(19) United States
(12) Patent Application Publication
(10) Pub. No.: US 2005/0137908 A1
(43) Pub. Date: Jun. 23, 2005

(54) Methods and apparatus for externally controlling a software application to create new application behavior

(75) Inventors: David Fusari, Groton, MA (US); Robert Seliger, Winchester, MA (US); Ralf Michael Klein, Stow, MA (US)

Correspondence Address: Richard F. Giunta;Wolf, Greenfield & Sacks, P.C., 600 Atlantic Avenue, Boston, MA, 02210-2206, US

(73) Assignee: Sentillion Inc., Andover, MA (US)

(21) Appl. No.: 11/021,755

(22) Filed: Dec. 23, 2004

Related U.S. Application Data
(60) Provisional application No. 60/532,245, filed on Dec. 23, 2003.

(51) Int. Cl. G06F 17/60

(52) U.S. Cl. 705/2; 705/3

(57) ABSTRACT

One embodiment is a method for use in a system comprising a plurality of software applications relating to healthcare and a context manager to facilitate sharing of a context between at least two of them, the context comprising a plurality of subjects including a patient subject and a user subject. The software applications comprise a first application and a target application, wherein the target application has no natively programmed capability to share the context. The method comprises providing a manipulator program that provides the target application with the capability to share the context. Another embodiment is a method for use in a system comprising a target computer having a user interface hosting environment and a target application executing thereon. The method comprises providing a manipulator program that hooks into the user interface hosting environment to provide inputs to the target application substantially simultaneously with inputs provided from a user. A further embodiment is a method of providing a manipulator program that is external to the target application and hooks into at least one application interface for the target application that is not natively programmed to be an interface to an independent external program, wherein the manipulator program is programmed to, after a user has logged into the target application, communicate with the target application via the application interface to provide the target application with a capability to perform at least one function not natively programmed.

### FIELD OF THE INVENTION

The present invention relates to techniques for controlling a software application by a program external to-the application for the purpose of achieving behavior that the application was not necessarily constructed to perform.

### BACKGROUND OF THE INVENTION

There exist commercial endeavors in which a plurality of computer applications shares a set of entities or subjects which are common to the applications. For example, in the field of medicine, a user may provide input describing a given patient to multiple applications. The input may be clinical information, such as x-ray images or blood work results, financial information, such as insurance coverage or billing history, or other types of information. The user's task historically entailed repeating the entry of data describing the patient into the multiple applications. Although patient data is an illustrative example, this practice extends to data describing other subjects as well, such as a user (i.e., to enable “single sign-on,” wherein a user logs in to a single network-based resource and is automatically given access to other authorized network-based resources), patient encounter, clinical provider, observation, insurer, or other subject. The use of shared information among multiple applications is not limited to the healthcare field.

Data which describes a given subject, and which is used commonly by a plurality of applications, is referred to herein as a “context” defined by that subject. The desirability of managing context in the healthcare industry, so that a user need not repeatedly enter information for a subject into multiple applications, has been recognized. To this end, a standard for context management, known as the Health Level Seven (HL7) context management specification, was first published in 1999 by the Clinical Context Object Workgroup (CCOW) (hereafter “the CCOW standard”). The CCOW standard defines a context management architecture (CMA) and processes for managing information describing a subject across a range of clinical and other healthcare-related applications. The nature of the communication to support the CCOW standard is described in HL7 Context Management “CCOW” Standard: Component Technology Mapping: Active X, Version 1.4, January 2002; HL7 Context Management “CCOW” Standard: Technology- and Subject-Independent Component Architecture, Version 1.4, January 2002; HL7 Context Management “CCOW” Standard: Subject Data Definitions, Version 1.4, January 2002; HL7 Context Management “CCOW” Standard” Component Technology Mapping: Web/HTTP, Version 1.4, January 2002; and HL7 Context Management “CCOW” Standard: User Interface: Microsoft Windows and Web, Version 1.4, January 2002, each of which is incorporated herein by reference.

### SUMMARY OF THE INVENTION

One embodiment is directed to a method for use in a computer system comprising a plurality of software applications relating to healthcare and a context manager to facilitate sharing of a context between at least two of the plurality of software applications, the context comprising a plurality of subjects including a patient subject and a user subject, wherein the plurality of software applications comprises a first application and a target application, wherein the target application has no natively programmed capability to share the context with the first application. The method comprises an act of providing a manipulator program that is external to the target application and provides the target application with the capability to share the context with the first application. Another embodiment is directed to a computer readable medium encoded with instructions that, when executed, perform the method.

Another embodiment is directed to a method for use in a computer system comprising a target computer having a user interface hosting environment, the target computer having a target application executing thereon, the target application having a user interface executing on the user interface-hosting environment. The method comprises an act of providing a manipulator program that is external to the target application and hooks into the user interface hosting environment to provide inputs to the target application substantially simultaneously with inputs provided from a user to the target application via the user interface. Another embodiment is directed to a computer readable medium encoded with instructions that, when executed, perform the method.

A further embodiment is directed to a method for use in a computer system comprising a target computer having a user interface hosting environment, the target computer having a target application executing thereon, the target application having a user interface executing on the user interface hosting environment. The method comprises an act of providing a manipulator program that is external to the target application and hooks into at least one application interface for the target application that is not natively programmed to be an interface to an independent external program, wherein the manipulator program is programmed to, after a user has logged into the target application, communicate with the target application via the application interface to provide the target application with a capability to perform at least one function that is not natively programmed into the target application. Another embodiment is directed to a computer readable medium encoded with instructions that, when executed, perform the method.

Another embodiment is directed to a method for use in a computer system comprising at least one computer executing a plurality of applications, the plurality of applications comprising a first application and a target application, wherein the target application has no natively programmed capability to enable the target application to be synchronized with the first application, wherein the target application has a user interface executing on a target computer having a display. The method comprises an act of providing a manipulator program that is external to the target application and provides the target application with a capability to perform at least one function that is not natively programmed into the target application and enables the target application to be synchronized with the first application, the at least one function being selected from the group consisting of: outputting onto a display of the at least one computer information that the target application is not programmed to output; monitoring a state of the target application and transmitting information to the first application in response to a change in state of the target application; and filtering information that the target application attempts to output to the display so that the filtered information is not outputted to the display. Another embodiment is directed to a computer readable medium encoded with instructions that, when executed, perform the method.

### BRIEF DESCRIPTION OF THE DRAWINGS

FIG. 1 is a block diagram of a computer system environment including a manipulator in accordance with one embodiment of the present invention;

FIG. 2 illustrates exemplary types of application programs, for use with a manipulator in accordance with one embodiment, that have a user interface component that executes on one computer and another component that performs at least some of the processing of the application and executes remotely; and

FIG. 3 is a block diagram of a computer system including a target application having a user interface component that executes on one computer and another component that executes remotely, and illustrates an embodiment of the present invention that employs a communication manager to monitor and/or manipulate communication between the components of the target application.

### DETAILED DESCRIPTION OF ILLUSTRATIVE EMBODIMENTS

Applicants have appreciated that not all healthcare applications support the CCOW standard. Bringing the power of context management according to the CCOW standard to applications that do not support the CCOW standard conventionally requires modifying the application's program, which is not always practical. For example, a software provider or other entity that desires to enable an application to participate in sharing context may not have control over the code of one or more applications programs, such that it may not have the ability to change the application's program. Thus, in accordance with one embodiment of the present invention, techniques are employed to externally control a software application to enable it to communicate with other application programs in accordance with the CCOW standard. As an example, the application can be modified (or manipulated) to inform it whenever (a) the context changes via a user gesture directed at another application, and (b) to sense whenever a gesture directed at the application should be treated as the source of a context change that is then conveyed to other applications. Embodiments of the invention described herein enable the creation of context management behavior among one or more applications even though the application(s) do not natively support context management and/or the CCOW standard.

While a specific example described herein relates to context management according to the CCOW standard, the invention is not limited in this respect, and can be used to enable an application to participate in context sharing in ways that differ from the CCOW standard, even if the application does not natively support such context sharing. Furthermore, the aspects of the present invention described herein are not limited to controlling software applications to participate in context sharing, and can be used to enable application behaviors of any type. Thus, the aspects of the present invention described herein can be used to allow a software application to be externally controlled to create any desirable application behavior not natively supported by the application program, as the aspects of the present invention are not limited to controlling a software application to create any particular type of application behavior.

A computer-based application intended for use by people is comprised of one or more software programs (used herein to refer to any computer code) that perform various computations and/or tasks, and a user interface via which the user controls the underlying program(s) and via which the application presents information to the user. The functionality of the application is expressed, at least in part, by the controls and commands that the user can access via its user interface. It is generally not possible to alter the functionality of an application unless (a) the application is configurable or (b) the underlying application program(s) are modified. When an application's behavior is configurable, the types of functionality that can be configured generally is limited to a specific set of functions built into the application. Extending the application beyond these functions generally is not possible other than through changes to the application's program(s), which can be difficult or impossible to do for technical or legal reasons when the person or entity desiring to modify the program(s) is not the person or entity who created and/or has ownership rights in the program(s).

Technologies have been developed that enable the external programmatic manipulation of an application via its user interface. These technologies (sometimes referred to as “screen scraping”) simulate user gestures as they might otherwise be issued by an actual user via a keyboard, mouse, and/or other user input device. These technologies often also provide a capability to programmatically “read” the information presented by the application. This enables a program external to the application to simulate a user's input to stimulate the application, and then to observe how the application has responded. For example, automated application testing programs simulate user input, observe the application's response, and compare the actual response to an expected response to determine whether the application behaved correctly.

There are a number of limitations with existing technologies that enable the programmatic manipulation of an application via its user interface. The most significant limitation is that these technologies are intended to run in isolation of the user. These technologies were not conceived to run in conjunction with the user, and as such, are susceptible to errant behaviors and/or confusing the user if the user were to interact with the application at the same time the application is being manipulated by an external program. In addition, these technologies typically are designed to test and/or monitor the performance of the application, and are not designed to alter the functionality of the application by enabling the application to perform functions that it is not natively capable of performing. Furthermore, these technologies were not conceived for use in coordinating a collection of otherwise independent applications. Finally, some applications are not suitable to being manipulated via their user interfaces, as their user interfaces are not conducive to programmatic manipulation, such that existing technologies that interact with an application via its user interface are not suitable for manipulating such applications.

One embodiment of the present invention provides a technique for enabling one or more programs external to an application to nevertheless manipulate the application to create new application behavior independent of how the application was natively programmed or implemented, and without requiring alterations to the application's programs. In some embodiments, these external manipulations can be performed concurrently with a user interacting with the same application in a manner which ensures that the user's actions and the external program's actions do not interfere, but the present invention is not limited to providing concurrent manipulation.

The aspects of the present invention that relate to providing external manipulations concurrently with the user can enable an external program to provide inputs to a target application substantially simultaneously with inputs received from a user. It should be appreciated that it is not technically feasible for an application program to receive, via its user interface, inputs from two different sources exactly simultaneously, such that some aspects of the present invention avoid incompatible input conflicts. However, aspects of the present invention enable an external manipulator program to provide inputs substantially simultaneously with inputs provided from a user. As used herein, the provision of inputs substantially simultaneously is intended to indicate a degree of simultaneous interaction that provides a level of usability to the user so that the user does not perceive that the application program is interfering with the user's ability to provide inputs to the application program, such that the interaction of the external manipulator program with the target application program is substantially transparent, such that the user either perceives no interference with his/her use of the target application or only very minor interference.

In another embodiment of the invention, techniques are provided that enable groups of applications in use by a user to be externally manipulated in a coordinated fashion to achieve an overall external, programmatic, orchestration of a collection of applications.

One exemplary use for the aspects of the present invention is to allow external, programmatic application manipulation to achieve context sharing for at least one application that does not natively have the capability of participating in context sharing. The context sharing can be performed in accordance with the CCOW standard referenced above, or in any other suitable way. As an example of context sharing, a user gesture directed at any one particular application may cause a similar response from one or more otherwise independent applications.

As mentioned above, while the aspects of the present invention described herein can be employed to enable an application that is not specifically configured to share context to participate in a context sharing environment, the present invention is not limited in this respect, and can be used for numerous other applications. In this respect, aspects of the present invention can be employed to provide an application with any desired functionality that it is not natively configured to provide. The nature of the functionality provided is not limited in any respect, as any desired functionality can be achieved using the aspects of the present invention described herein. As one example, one or more operations that a user might otherwise need to manually perform to accomplish a task via one or more otherwise independent applications can be performed by an external program for the purpose of automating the task. As another example, application reshaping can be performed, such that the appearance and/or controls inherently offered by an application (or group of applications) to the user may be altered through external programmatic manipulation. The alterations can take any suitable form, including deleting, adding to and/or restructuring the controls and/or other appearances presented by the application.

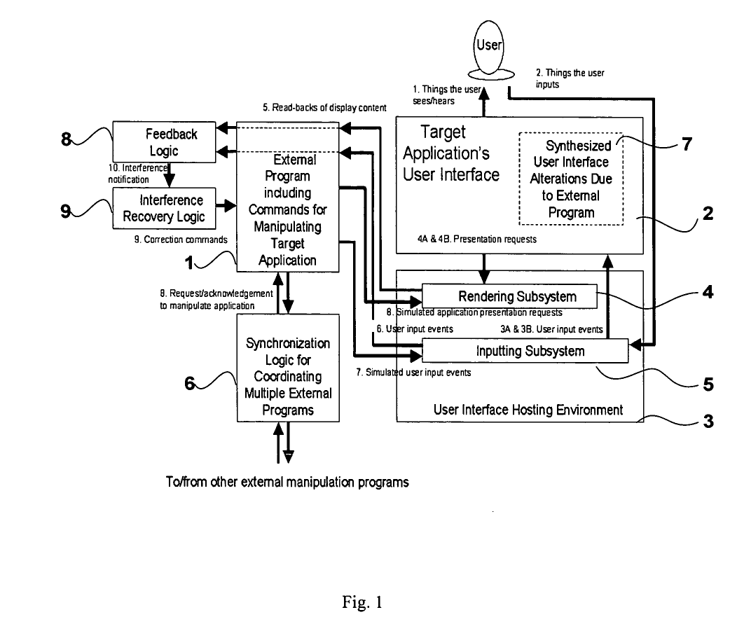

One illustrative embodiment of the present invention will now be described referring to FIG. 1. It should be appreciated that this embodiment is merely illustrative of techniques for implementing the various aspects of the present invention described herein, and that the invention is not limited to this particular implementation, as numerous alternative implementations are possible.

In the embodiment of FIG. 1, an application manipulator 1 is provided that contains a program with commands to manipulate a target application 2, via its user interface 2a, to accomplish one or more desired tasks (e.g., context sharing, user simulation, application reshaping, or any other desired task). The target application's user interface 2a is deployed on a hosting environment 3 such as an operating system, web browser, terminal emulator, or other suitable environment, executing on one or more computers (e.g., a desktop computer). The hosting environment 3 includes at least two subsystems: a presentation rendering subsystem 4 that is responsible for generating a visual display for the application (e.g., on a monitor coupled to the computer on which the hosting environment 3 is resident) in response to presentation requests sourced by the application 2, and an inputting subsystem 5 that is responsible for relaying user input events (e.g., that originate via a mouse or keyboard) to the application 2. As mentioned above, the aspects of the present invention described herein are not limited to use in an environment having a target application user interface 2a, hosting environment 3, rendering subsystem 4 and inputting subsystem 5 configured as shown, and can be employed with applications executing in any computer environment.

The manipulator 1 may generate inputs and send them to the inputting subsystem 5. The manipulator 1 can determine when to send these inputs in any suitable manner. In one embodiment, the manipulator program 1 executes a series of manipulation instructions that generate inputs to the target application (e.g., via the inputting subsystem 5) to perform certain manipulations based upon the receipt of external events from another application or from user inputs provided to the target application. For example, in the healthcare context management environment, the manipulator 1 may generate inputs (similar to those provided by a user) that select a particular patient whenever the manipulator is informed that a user has selected that patient via another application that shares context with the target application. In another embodiment, the manipulator 1 may make decisions as to the inputs to generate based upon observations obtained by monitoring the target application's presentation state. For example, in the healthcare context management environment, the manipulator may detect that a particular menu has been presented by the target application and may take action based upon such detection. The action may take any of numerous forms. For example, additional or different choices may be added to the menu than normally are presented by the target application. This class of manipulations is discussed further below. In one embodiment, the decision as to when to perform such a manipulation is triggered by an observation made by the manipulator program while monitoring the presentation of the target application.

It should be appreciated that the embodiments of the present invention described above wherein the manipulator 1 generates inputs to the target application based upon the receipt of external events (e.g., an action taken by another application) or by monitoring the target application's presentation state can be employed separately, or together, such that in one embodiment of the present invention, inputs can be generated in response to the receipt of external events and/or the target application's presentation.

There are many ways in which the manipulator 1 may monitor the target application, and the aspects of the present invention that relate to monitoring the target application are not limited to any particular implementation technique. Illustrative monitoring techniques include, but are not limited to, reading the text buffer used by the rendering subsystem 4 to hold text rendering requests issued by the target application, reading bitmap images from the rendering subsystem 4 and comparing the read bitmaps to expected maps, etc. In this respect, it should be appreciated that the rendering subsystem 4 may generate bitmaps for characters to be displayed on a display device, and that one possible monitoring technique is to monitor the bitmaps to determine when bitmaps indicative of a specific state to be identified are provided by the rendering subsystem 4. This technique can be used to enable the manipulator 1 to determine that the target application is in a particular state. Given an understanding of the state the target application is in by observing the application via the rendering subsystem 4, the manipulator 1 can generate one or more user inputs, e.g., via the inputting subsystem 5, that cause the target application to do something that it would not otherwise do on its own accord.

In accordance with one embodiment of the present invention, the monitoring performed by the manipulator 1 can further include monitoring of user inputs (e.g., keystrokes, mouse clicks) by monitoring the inputting subsystem 5 in FIG. 1 or otherwise to determine inputs provided by the user and can take any desired action based thereupon. For example, when used in connection with the embodiment of the invention that relates to providing a target application with a context sharing capability, the manipulator 1 can send a communication to another application to cause it to share context with the target application based upon inputs provided by the user.

In another embodiment of the invention discussed in more detail below, the manipulator 1 may interface with the target application 2 in a manner other than via its user interface 2a. Such techniques can be employed to generate inputs to manipulate the target application, and/or to monitor information concerning the target application as discussed in more detail below.

In one embodiment, the manipulator 1 may instruct the inputting subsystem 5 to block inputs from the user 10 while the manipulator's generated inputs are being processed by and acted upon by the target application. Similarly, the manipulator 1 may hold back on sending its generated inputs to the inputting subsystem 5 when it determines that the user 10 is in the midst of inputting data and/or the target program is in the midst of responding to inputs from the user. In this manner, simultaneous interaction between the user 10 and the manipulator 1 is facilitated. While advantageous, the present invention is not limited to a manipulator that implements a blocking capability in the above-described manner, or to one that facilitates simultaneous interaction with the user.

In another embodiment of the present invention, one or more inputs from the user 10 may be blocked altogether by the manipulator 1, so that the inputs do not reach the target application, to implement functionality that is performed by inhibiting the processing of such inputs. It should be appreciated that any suitable technique may be employed to block inputs from the user 10 to the target application, as the aspect of the present invention that relates to the blocking of user inputs is not limited to any particular implementation technique. For example, some operating systems provide the capability of disabling a particular input device (e.g., a cursor or keyboard) for all applications executing or for particularly specified applications. In addition, some operating systems queue the inputs received from one or more input devices and may provide the capability to have another application (such as the manipulator 1) manipulate the queue to remove and/or modify inputs provided therein so that such inputs either do not reach the target application or reach the target application in a modified form. These are examples of techniques whereby the inputs provided to the target application can be blocked or manipulated, but the present invention is not limited to any particular implementation technique.

In the embodiments of the invention discussed above wherein inputs from the user can be blocked, it should be appreciated that the inputs may be blocked only for the target application, or for multiple applications in use by the user concurrently.

In one embodiment, the manipulator 1, while it is external to the target application, may nevertheless alter the target application's appearance and/or user functions (as shown at 7 in FIG. 1) by adding or removing information (e.g., application controls) from the presentation made by the application program. For example, it may be desired to add certain controls, icons, and/or data labels to the presentation of the target application to provide the user with functions, visual cues and/or other information that the target application does not natively support. For example, in the case of context management, it may be desirable to add an icon to the user interface presented by the target application that indicates to the user that the application is presently sharing context with other applications. Alternatively, it may be desirable to hide or remove controls so that the user is not able to perform actions that would be inappropriate for the modified functionality enabled by the manipulator. For example, in the case of context management, it may be desirable to hide any control that enables the user to log off of the target application, as this function may be subsumed by another program.

In a system comprised of multiple target applications, the manipulator 1 may manipulate more than one target application at a time and/or there may be multiple manipulators operating concurrently. When multiple manipulators are employed together (e.g., implemented as multiple manipulator software programs), each may manipulate one or more different applications and/or different manipulators may manipulate different aspects of the same target application. In one embodiment, multiple manipulators may be coordinated so that they do not interfere with each other while manipulating target applications. This can be done in any suitable way. In one embodiment, synchronization logic 6 is provided for the manipulators, and may, for example, ensure suitable ordering and prioritization of otherwise concurrent manipulation actions. As indicated above, this can be implemented in any suitable way (e.g., by a mutually exclusive first-in first-out buffer), as the aspect of the present invention that performs synchronization is not limited to any particular implementation technique. In addition, it should be appreciated that the aspect of the present application that employs multiple manipulators is not limited to use with synchronization logic for coordinating between them. Similarly, it should be appreciated that the aspects of the present invention described herein are not limited to use with a system that employs multiple manipulators, as a single manipulator can be employed.

In another embodiment, the manipulator 1 may also incorporate two additional components: a feedback logic component 8 that monitors whether or not the generated inputs sent by the manipulator to the target application have had the desired affect, and an interference recovery logic component 9 that determines actions to be taken by the manipulator 1 to recover from an unsuccessful attempt to manipulate the target application. One potential cause of an unsuccessful manipulation is when an input from the user has become intermixed with one or more generated inputs from the manipulator program. Examples of recovery steps that may be performed by the recovery logic component 9 include (a) resending some or all of the original generated inputs to the target application; (b) sending generated inputs that do the opposite of any inputs that were successfully received in order to “unwind” the target application and then resending the original generated inputs to the application; and (c) generating an error message for the user via the synthesized target application user interface extension 7. The feedback logic component 8 can perform the monitoring to ensure that the generated user inputs have had the desired effect of the target application in any suitable way, as the present invention is not limited to any particular implementation technique. For example, monitoring techniques such as those discussed above can be employed to determine whether the target application has reached a desired state as a result of the generated inputs. The feedback logic component 8 and recovery logic component 9 can be implemented in any suitable manner (e.g., as one or more software programs) as the aspects of the present invention that employ these components are not limited to any particular implementation technique.

As discussed above, one embodiment of the present invention is directed to a technique for enabling an application that does not natively support context sharing in general, nor context sharing in accordance with the CCOW standard in particular, to participate in a context sharing environment. Thus, one embodiment of the present invention is directed to providing a separate manipulator (e.g., a manipulation program) that is external to the application program and that interacts with the application program (through its user interface or otherwise) to enable the application program to participate in a context sharing environment, which can be in accordance with the CCOW standard or not. It should be appreciated that the provision of a separate manipulator ensures that the application program itself need not be modified. This enables a third party software provider to provide context sharing functionality for one or more other applications, despite not having the ability to modify the application(s). Of course, the aspects of the present invention described herein are not limited in this respect, as a manipulator that provides context sharing functionality for an application by interacting with the application (through its user interface or otherwise) can also be provided by the same vendor that provides the application.

It should be appreciated that the embodiment of the present invention that allows a separate manipulator to manipulate a target application to provide certain functionality (e.g., context sharing) differs from applications in which the desired functionality is natively provided. In an application that itself supports certain functionality, the application program itself provides internal communication techniques to implement the desired functionality, such that the desired control of the application is not implemented externally, through the user interface or otherwise.

As discussed above, one embodiment of the present invention relates to manipulating and/or monitoring an application through its user interface. As mentioned above, the user interface may include an inputting subsystem 5 and a rendering subsystem 4. It should be appreciated that as used herein, the reference to manipulating the target application through the rendering subsystem portion of the user interface can include not only identifying characters that may be themselves rendered for display on a display device, but can also include outputs therefrom that are representative of information indicative of a state of the target application, examples of which include a URL that designates a web page that will be called by the application, an identifier of a particular screen that may be provided on the display device, or any other handle or other indicator of information to be presented by the user interface.

As discussed above, in accordance with one embodiment of the present invention, applications can be externally manipulated via their user interfaces. However, the present invention is not limited in this respect, as in an alternate embodiment of the present invention, one or more applications is externally manipulated using an alternate technique that does not communicate with the target application via its user interface. The alternate embodiment of the present invention can be employed for any desired reason, as the invention is not limited in this respect. For example, some applications may employ a user interface that is subject to change through different versions of the application. As it may be desirable to employ a single manipulator capable of manipulating multiple versions of the application without requiring changes to the manipulator, it may be desirable to interact with the target application using aspects thereof that are likely to be stable over different versions of the target application.

As another example, the user interfaces employed by some applications may present particular difficulties in allowing the application to be manipulated and/or monitored via the user interface. One example of such an application is a proprietary terminal emulator that uses its own rendering techniques, as opposed to relying upon the capabilities provided by the hosting environment (e.g., a display device driver provided by an operating system) to render information to the display. As will be appreciated by those of skill in the art, a terminal emulator is an application that runs on a desktop or other computer and provides access to an application running on a mainframe computer remote therefrom. The terminal emulator presents the application as if it is running on the desktop, as opposed to executing on the remote mainframe. While some terminal emulators may have a natively programmable application programming interface (API) that can be employed to communicate with a manipulator through the user interface in a manner similar to that described above, others do not. For such other terminal emulators, it may be desirable to employ an alternate technique for manipulating the application.

While providing stability over multiple versions of an application and use with a terminal emulator that has no natively programmable API are two examples of reasons for providing an alternate technique of manipulating an application other than through its user interface, it should be appreciated that the aspect of the present invention that enables application manipulation other than through its user interface is not limited in this respect, and can be employed to manipulate any suitable application for any reason.

Applicants have appreciated that one characteristic of an application that executes on a mainframe and has a terminal emulator executing on a desktop is that there is a physical communication medium between the terminal emulator and the mainframe by which they exchange information. Applicants have further appreciated that in at least some circumstances, the manipulator can monitor and manipulate such an application by tapping into the communication medium through which the terminal emulator communicates with the application executing on the mainframe.

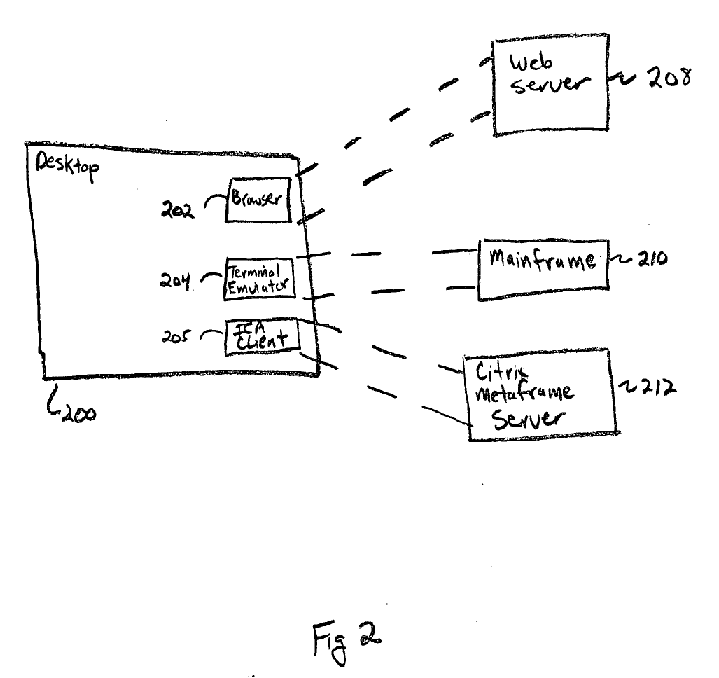

Other types of application programs in addition to those that execute with a terminal emulator share the characteristic of having a user interface component that executes on one computer (e.g., a desktop) and another component that performs at least some of the processing of the application and executes remotely. Examples of some such applications are shown in FIG. 2, which illustrates a desktop 200 having a number of applications executing thereon, including a browser 202, a terminal emulator 204, and an Independent Computing Architecture (ICA) client, which is a client emulator using the Citrix MetaFrame and ICA client architecture available from Citrix Systems, Inc. of Fort Lauderdale, Fla. The browser 202 provides access to one or more applications (not shown) executing on one or more web servers 208. Similarly, the terminal emulator 204 provides access to an application (not shown) executing on a mainframe computer 210 in the manner discussed above, and the ICA client 205 provides access to an application program executing on a Citrix MetaFrame server 212. The desktop 200 communicates with each of the web server 208, mainframe computer 210 and Citrix MetaFrame server 212 via at least one communication medium, which typically is a network but which may take other forms. It should be appreciated that the applications executing on the remote computers 208, 210 and 212, exchange information with their corresponding user interfaces (202, 204 and 205, respectively) resident on the desktop 200. In accordance with one embodiment of the present invention, the applications can be monitored and/or manipulated by the manipulator by monitoring and/or manipulating this communication.

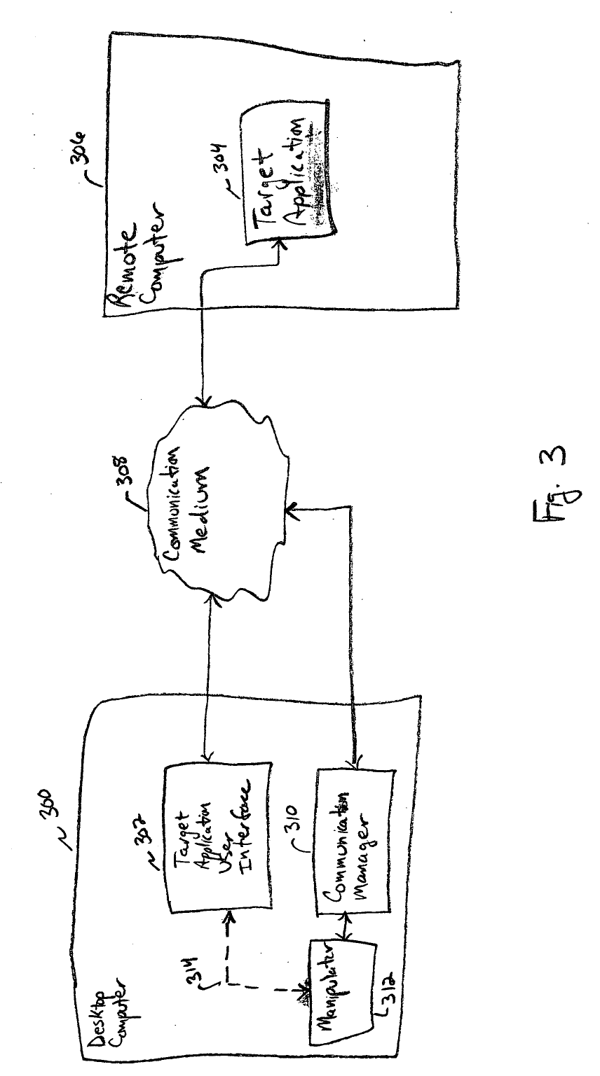

One embodiment of the present invention for use with target applications that have a user interface executing on a desktop but other components that execute on a remote computer will now be described referring to FIG. 3. FIG. 3 illustrates a computer system including a desktop computer 300 having a target application user interface 302 executing thereon, with the target application 304 executing on a remote computer 306. The desktop 300 and the remote computer 306 are coupled together via a communication medium 308, which can take any suitable form, as the present invention is not limited to use with a computer system via which the computers 300 and 306 communicate in any particular manner. As one example, the communication medium 308 may be a private or public network, with the user interface 302 and target application 304 communicating using any suitable networking communication protocol (e.g., TCP/IP).

In accordance with one embodiment of the present invention, a communication manager 310 is provided to monitor and/or manipulate communication between the target application user interface 302 and the target application 304 over the communication medium 308. While the communication manager 310 is illustrated in the embodiment of FIG. 3 as being implemented on the desktop 300, it should be appreciated that the present invention is not limited in this respect. The communication manager 310 can be implemented in any suitable manner. When implemented in software, the communication manager can be executed anywhere on the computer system, including on the desktop, the remote computer 306, and/or in one or more networking devices separate from the desktop 300 and remote computers 306, in either an integrated or distributed manner. In addition, while the communication manager 310 is illustrated as communicating with the communication medium 308 external to the desktop and remote computers 300, 306, it should be appreciated that the communication manager 310 can alternatively monitor and/or manipulate communication between the target application user interface 302 and the target application component 304 by being coupled to a portion of the communication path between the user interface 302 and the target application component 304 that is internal to the desktop 300 and/or the remote computer 306.

In the embodiment illustrated in FIG. 3, the communication manager 310 is coupled to a manipulator 312 that performs many of the same functions as the manipulator program 1 described above in connection with FIG. 1. However, rather than communicating (e.g., monitoring and/or manipulating) with the target application's user interface 302 via a user interface hosting environment 3 as in the embodiment of FIG. 1, the manipulator 312 can communicate with the target application via the communication manager 310. In accordance with one embodiment of the present invention, this may be the exclusive vehicle for communication between the manipulator 312 and the target application 304. However, in an alternate embodiment of the invention, as illustrated by the dotted line 314 in FIG. 3, the manipulator 312 optionally may also communicate with the target application user interface 302 (e.g., via a user interface hosting environment on the desktop computer 300 in the manner discussed above in connection with the embodiment of FIG. 1).

In the embodiment illustrated in FIG. 3, the communication manager 310 can monitor the flow of information between the target application user interface 302 and the target application 304 in any suitable manner (e.g., by examining packets traveling over a network when the communication medium 308 includes a network), and can provide information relating to this communication to the manipulator 312. The manipulator 312 can be programmed to recognize any desired types of communication between the user interface 302 and the target application 304 and to take any desired action in response. As an example, the manipulator 312 can be programmed to recognize one or more control sequences between the user interface 302 and the target application 304 and to recognize any application data or other content included therein. For example, the manipulator 312 may be programmed to recognize various screen presentations provided by the target application to the user interface 302, to understand the hierarchy of such presentations and to glean from them actions being taken by and/or states of the target application 304. In one example relating to the illustrative embodiment involving a context sharing environment relating to the sharing of medical information, the manipulator 312 can be programmed to recognize a control sequence whereby the user interface 302 requests information for a new patient, and then after the user enters an identifier for a new patient, can communicate with other applications sharing context with the target application 304 to perform a context switch to the new patient.

It should be appreciated by monitoring the communication traffic between the user interface 302 and the target application 304, the manipulator 312 may be able to make determinations as to the status or state of the target application, including the nature of the display screens presented thereby, without directly monitoring the display or the rendering subsystem in the manner described above in connection with FIG. 1.

As mentioned above, in accordance with one embodiment of the present invention, the manipulator 312 can not only monitor the state of the target application 304 by monitoring communication with the user interface 302 via the communication manager 310, but in one embodiment can also manipulate the target application 304 to achieve functionality not natively provided thereby, in much the same manner as discussed above in connection with the embodiment of FIG. 1. In this respect, by understanding the control flow between the user interface 302 and the target application 304, the manipulator 312, via the communication manager 310 and/or via the optional communication path 314, can simulate user commands and/or otherwise manipulate the behavior of the target application 304.

It should be appreciated that although the embodiment described above in connection with FIG. 3 is one in which the manipulator 312 can both monitor and manipulate (e.g., alter) the behavior of the target application 304, the embodiment of the present invention that employs a communication manager 310 is not limited in this respect, as in other embodiments the manipulator 312 can perform solely a monitoring of the target application 304.

It should be appreciated that some computer systems may employ a security protocol (e.g., encryption) to protect the secrecy of communication between the target application 304 and a remote user interface 302. When used in connection with such a computer system, it may be desirable to enable the communication manager 310 to have the capability of accessing the secured communication (e.g., by having an appropriate decryption key).

A specific example of a technique for providing functionality to an application that does not natively support that functionality will now be described. The example relates to implementation of a manipulator program (referred to as a bridge) to enable the MAGIC application, available from Medical Information Technology, Inc. of Westwood, Mass. (hereafter the MAGIC application) to participate in a context sharing environment in accordance with the CCOW standard. Again, it should be appreciated that this is merely one example of an application for the use of the aspects of the present invention described herein, as the present invention is not limited to the context sharing of applications (in accordance with the CCOW standard or otherwise) nor to use with the MAGIC application or any other specific application.

In accordance with one embodiment of the present invention, a manipulator program similar to that described above is provided to enable the MAGIC application to participate in context sharing in accordance with the CCOW standard. This context sharing functionality can be performed by a manipulator program that implements interception techniques of capturing calls to both the rendering subsystem 4 and inputting subsystem 5 of a user interface hosting environment as described above, the infrastructure of such a hosting environment when operating on an operating system platform employing the Windows operating system available from Microsoft Corporation, and scripting tools made available by the vendor.

In one embodiment, the context sharing functionality that the manipulator provides can include a single sign on capability wherein the user need only sign on to one of a plurality of applications sharing context and is automatically signed to the others, single sign off capability whereby a user need only sign off of one application sharing context with one or more other applications and is automatically signed off of all, following a patient context selection made by another application, and monitoring the selection of a patient via the MAGIC application to enable other applications sharing context with it to appropriately change their patient selections. The single sign on functionality can include password learning for initial deployment and invalid passwords. For example, password learning can include querying the user to determine the user's password for a target application, and storing the password so that it is accessible to the manipulator for use in signing on to the application. In addition, the manipulator can be programmed so that in the event that a stored password becomes out of date or is otherwise invalid, in response to the target application indicating that the password is invalid, the manipulator can again initiate a querying process to learn the correct password.

In accordance with one embodiment for use with the MAGIC application, the single sign on functionality can be achieved by employing a scripting interface provided by the vendor to read and write to the display screen. The scripting interface can sign on to the MAGIC application in response to a user signing on to another application that shares context with it. The scripting interface can be employed to script from a first start up window to a log in window, and a userid and password received from the context management system can be employed to log into the application. If the userid and password combination is unrecognized by the MAGIC application, the manipulator may display a learning dialog box on top of the MAGIC application and ask the user for the correct password. If the entered password is correct, the correct password may be provided to the context management system to be stored for later use. If the correct password is not entered, the manipulator program may enter an error message indicating that it could not log the user into the application and then allow the user to manually log in, but outside of the context sharing capability provided by the manipulator program.

In accordance with one embodiment of the invention, the single sign off functionality may also be implemented using a scripting interface provided by the vendor, and may be used whenever there is a change in the user context, or if the manipulator program is instructed to close by another application, such as a launchpad application described in co-pending Ser. No. 09/645,051 entitled, “APPLICATION LAUNCHPAD”, which is incorporated herein by reference. The user may be logged out in response to an instruction to close the MAGIC application because Applicants appreciated that if it were closed with a patient selected, the MAGIC application would undesirably lock records. The manipulator program may use the scripting interface to read the display screen and, depending upon the number of lines present for the screen and text, may implement a combination of keystrokes to navigate to previous desired screens. By keeping track of the last two screens read, the manipulator program may determine whether it has become stuck in an undesired state and is unable to navigate the MAGIC application into a logged out state. When it determines that it was in fact stuck, the manipulator program may cease looking at the scripting interface to identify what information is on the display screen, and may send a series of keystrokes previously determined to get the MAGIC application out of the undesired state, and would then revert to monitoring the screen and navigating back to a logged out state in the manner described above.

The monitoring of a patient selection change performed manually on the MAGIC application can be implemented using the scripting interface provided by the vendor in combination with some involvement by the manipulator program. In this respect, the manipulator program can be employed to slow down the MAGIC application to ensure that when it writes a medical record number (MRN) to the screen, the scripting interface provided by the vendor has sufficient time to read it. This involvement by the manipulator program can be performed when the manipulator program launches the MAGIC application. The manipulator program may employ the scripting interface to read the top level of a window of the MAGIC application, whereby the bridge scans the text strings for preceding text that is known to appear before an MRN. When the appropriate text strings are found, the manipulator program reads the four locations on the screen where the MRN could be found based upon the location of the preceding text, and checks to see whether a valid MRN is provided or not. When a valid MRN is provided, the manipulator program submits it to the context manager for sharing with the other applications in the context.

When a different instigator instigates a patient context change selection, one embodiment of the present invention employs an infrastructure of the windows operating system platform and the scripting interface provided by the vendor to change the patient identifier (the MRN) for the MAGIC application. The infrastructure for the windows operating system platform that is employed is a keyboard hook to the application that monitors all user inputs. In one embodiment, the MAGIC application is a terminal based application. As such, the user could potentially overtype menu selections in the application, so that the keyboard hook can be used to keep the pace of the keystrokes of the user processed by the application to the same speed the application is displaying them, thereby allowing the scripting interface to keep up with the user request.

To follow a patient selection from another application, the manipulator program may clear the current patient data from the MAGIC application and then navigate up through display screens presented by the MAGIC application until either a location is arrived at at which the patient MRN can be entered, or a specific menu is reached (referred to as an anchor point), at which point either the MRN is entered or the same menu item that the last user selected is selected and the patient ID is entered. Anchor points may be established dynamically by monitoring the application workflow and may be used to replay user interactions and drive the application to a known state.

It should be appreciated that the above-described technique employs a dynamic association or current window view, rather than laying out a complete tree menu structure for the MAGIC application in a context state machine, which enables the manipulator to be programmed in a manner that is independent of the version of the MAGIC application and can enable use with customized versions of the application which can vary depending upon not only site, but also location and user role.

The manipulator program begins by monitoring for a menu, and when the menu is identified, watches the set of characters directly left of the cursor, as that is where the menu option that the user selects will be written to the screen. The manipulator program can read and remember the user selection and can establish this selection and the current screen as the latest anchor point. When not monitoring for a menu selection, the manipulator program can wait for a patient context change to initiate the above-described techniques to achieve the following of a patient context selection. When a patient context change occurs, the manipulator program may first clear the patient data using the sign off functionality one screen at a time in the manner described above, and may continue going up screens until it determines that it has reached the last anchor point or that the cursor is at a patient selection screen. When it has reached an anchor point, the manipulator program may play back the last menu choice that the user typed in and then check to see if the MAGIC application is at a location to enter in the patient ID. If not, the manipulator program may rest on the screen doing nothing. When the MAGIC application is at a location where the patient ID can be entered, the manipulator program may enter the MRN into the selection field and select the patient. Once the patient is selected, the manipulator program may stop driving the MAGIC application and allow the user to take back full control of the application.

As mentioned above, the example described for enabling the MAGIC application to participate in a context sharing environment in accordance with the CCOW standard is provided as merely an example, as the aspects of the present invention are not limited to use with the MAGIC application or to providing context sharing capabilities for any application in accordance with the CCOW standard or otherwise.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. In a computer system comprising a plurality of software applications relating to healthcare and a context manager to facilitate sharing of a context between at least two of the plurality of software applications, the context comprising a plurality of subjects including at least a patient subject and a user subject, wherein the plurality of software applications comprises a first application and a target application, wherein the target application has no natively programmed capability to share the context with the first application, a method comprising an act of:
(A) providing a manipulator program that is external to the target application and provides the target application with the capability to share the context with the first application.

2. The method of claim 1, wherein the act (A) comprises an act of providing a manipulator program that provides the target application with a capability to communicate with the context manager in a manner that enables the target application to share the context with the first application.

3. The method of claim 1, wherein the act (A) comprises an act of providing a manipulator program that provides the target application with a capability to perform at least one function that is not natively programmed into the target application.

4. The method of claim 3, wherein the target application has a user interface executing on a target computer having a display, and wherein the at least one function results in outputting to the display information that the target application is not natively programmed to output to the display.

5. The method of claim 3, wherein the target application has a user interface executing on a target computer having a display, and wherein the at least one function results in filtering information that the target application attempts to output to the display so that the filtered information is not outputted to the display.

6. The method of claim 5, wherein the filtered information comprises at least one user selectable control feature that, when selected, causes the target application to perform an action, so that the filtering of the user selectable control feature prevents the user from selecting the control feature and causing the target application to perform the action.

7. The method of claim 4, wherein the information comprises at least one user selectable control feature that, when selected, causes the target application to perform an action.

8. The method of claim 1, wherein the target application has a user interface executing on a target computer having a user interface hosting environment, and wherein the act (A) comprises an act of providing a manipulator program that hooks into the user interface hosting environment to monitor the target application.

9. The method of claim 1, wherein the target application has a user interface executing on a target computer having a user interface hosting environment, and wherein the act (A) comprises an act of providing a manipulator program that hooks into the user interface hosting environment to manipulate the target application.

10. The method of claim 1, wherein the target application has a user interface executing on a first computer and another component executing on a second computer, wherein the first and second computers communicate via at least one communication path, and wherein the act (A) comprises an act of providing a manipulator program that has a communication manager that hooks into the communication path to manipulate the target application.

11. The method of claim 1, wherein the target application has a user interface executing on a first computer and another component executing on a second computer, wherein the first and second computers communicate via at least one communication path, and wherein the act (A) comprises an act of providing a manipulator program that has a communication manager that hooks into the communication path to monitor the target application.

12. The method of claim 1, wherein the act (A) comprises an act of providing a manipulator program that monitors the target application.

13. The method of claim 12, wherein the act (A) comprises an act of providing a manipulator program that, in response to a user of the target application taking an action that may impact the context shared with the first application, causing information relating to the action to be communicated to the first application.

14. The method of claim 13, wherein the action is a changing of a patient in the target application.

15. The method of claim 13, wherein the action is a user signing onto the target application.

16. The method of claim 13, wherein the action is a user signing out of the target application.

17. The method of claim 1, wherein the act (A) comprises an act of providing a manipulator program that manipulates the target application.

18. The method of claim 17, wherein the act (A) comprises an act of providing a manipulator program that, in response to a user of the first application taking a first action that should cause the target application to take a second action to share the context, manipulating the target application to cause the target application to take the second action.

19. The method of claim 18, wherein the second action is a changing of a patient in the target application.

20. The method of claim 18, wherein the second action is signing a user onto the target application.

21. The method of claim 18, wherein the second action is signing a user out of the target application.

22. The method of claim 9, wherein the act (A) comprises an act of providing a manipulator that hooks into the user interface hosting environment in a manner that enables the target application to receive inputs from the manipulator and a user substantially simultaneously.

23. The method of claim 3, wherein the act (A) comprises,an act of providing a manipulator that provides the target application with a capability to automatically perform at least one function that the target application is natively programmed to perform only in response to manual input from a user.

24. The method of claim 17, wherein the act (A) comprises an act of providing a manipulator program that comprises a monitor that monitors the target application to ensure that the target application acts in an expected manner when manipulated by the manipulator program, and that has the capability to recover when it is determined that the target application did not act in the expected manner.

25. The method of claim 1, wherein the target application has a user interface executing on a target computer having a user interface hosting environment, and wherein the act (A) comprises an act of providing a manipulator program that hooks into the user interface hosting environment and blocks at least one input provided by a user so that the at least one input is not provided to the target application.

26. The method of claim 1, wherein the context manager facilitates sharing of the context in accordance with a Clinical Context Object Workgroup (CCOW) standard, wherein the target application has no natively programmed capability to share the context with the first application in accordance with the CCOW standard, and wherein the act (A) comprises an act of:
(A) providing a manipulator program that provides the target application with the capability to share the context with the first application in accordance with the CCOW standard.

27. The method of claim 1, wherein the context comprises a patient encounter subject, a clinical provider subject and an insurer subject.

28. The method of claim 27, wherein the context comprises an observation subject.

29. A computer readable medium encoded with instructions for execution on a computer system comprising a plurality of software applications relating to healthcare and a context manager to facilitate sharing of a context between at least two of the plurality of software applications, the context comprising a plurality of subjects including at least a patient subject and a user subject, wherein the plurality of software applications comprises a first application and a target application, wherein the target application has no natively programmed capability to share the context with the first application, the instructions, when executed on the computer system, performing a method comprising an act of:
(A) implementing a manipulator program that is external to the target application and provides the target application with the capability to share the context with the first application.

30. The computer readable medium of claim 29, wherein the act (A) comprises an act of implementing a manipulator program that provides the target application with a capability to communicate with the context manager in a manner that enables the target application to share the context with the first application.

31. The computer readable medium of claim 29, wherein the act (A) comprises an act of implementing a manipulator program that provides the target application with a capability to perform at least one function that is not natively programmed into the target application.

32. The computer readable medium of claim 31, wherein the target application has a user interface executing on a target computer having a display, and wherein the at least one function results in outputting to the display information that the target application is not natively programmed to output to the display.

33. The computer readable medium of claim 31, wherein the target application has a user interface executing on a target computer having a display, and wherein the at least one function results in filtering information that the target application attempts to output to the display so that the filtered information is not outputted to the display.

34. The computer readable medium of claim 33, wherein the filtered information comprises at least one user selectable control feature that, when selected, causes the target application to perform an action, so that the filtering of the user selectable control feature prevents the user from selecting the control feature and causing the target application to perform the action.

35. The computer readable medium of claim 32, wherein the information comprises at least one user selectable control feature that, when selected, causes the target application to perform an action.

36. The computer readable medium of claim 29, wherein the target application has a user interface executing on a target computer having a user interface hosting environment, and wherein the act (A) comprises an act of implementing a manipulator program that hooks into the user interface hosting environment to monitor the target application.

37. The computer readable medium of claim 29, wherein the target application has a user interface executing on a target computer having a user interface hosting environment, and wherein the act (A) comprises an act of implementing a manipulator program that hooks into the user interface hosting environment to manipulate the target application.

38. The computer readable medium of claim 29, wherein the target application has a user interface executing on a first computer and another component executing on a second computer, wherein the first and second computers communicate via at least one communication path, and wherein the act (A) comprises an act of implementing a manipulator program that has a communication manager that hooks into the communication path to manipulate the target application.

39. The computer readable medium of claim 29, wherein the target application has a user interface executing on a first computer and another component executing on a second computer, wherein the first and second computers communicate via at least one communication path, and wherein the act (A) comprises an act of implementing a manipulator program that has a communication manager that hooks into the communication path to monitor the target application.

40. The computer readable medium of claim 29, wherein the act (A) comprises an act of implementing a manipulator program that monitors the target application.

41. The computer readable medium of claim 40, wherein the act (A) comprises an act of implementing a manipulator program that, in response to a user of the target application taking an action that may impact the context shared with the first application, causing information relating to the action to be communicated to the first application.

42. The computer readable medium of claim 41, wherein the action is a changing of a patient in the target application.

43. The computer readable medium of claim 41, wherein the action is a user signing onto the target application.

44. The computer readable medium of claim 41, wherein the action is a user signing out of the target application.

45. The computer readable medium of claim 29, wherein the act (A) comprises an act of implementing a manipulator program that manipulates the target application.

46. The computer readable medium of claim 45, wherein the act (A) comprises an act of implementing a manipulator program that, in response to a user of the first application taking a first action that should cause the target application to take a second action to share the context, manipulating the target application to cause the target application to take the second action.

47. The computer readable medium of claim 46, wherein the second action is a changing of a patient in the target application.

48. The computer readable medium of claim 46, wherein the second action is signing a user onto the target application.

49. The computer readable medium of claim 46, wherein the second action is signing a user out of the target application.

50. The computer readable medium of claim 37, wherein the act (A) comprises an act of implementing a manipulator that hooks into the user interface hosting environment in a manner that enables the target application to receive inputs from the manipulator and a user substantially simultaneously.

51. The computer readable medium of claim 31, wherein the act (A) comprises an act of implementing a manipulator that provides the target application with a capability to automatically perform at least one function that the target application is natively programmed to perform only in response to manual input from a user.

52. The computer readable medium of claim 45, wherein the act (A) comprises an act of implementing a manipulator program that comprises a monitor that monitors the target application to ensure that the target application acts in an expected manner when manipulated by the manipulator program, and that has the capability to recover when it is determined that the target application did not act in the expected manner.

53. The computer readable medium of claim 29, wherein the target application has a user interface executing on a target computer having a user interface hosting environment, and wherein the act (A) comprises an act of implementing a manipulator program that hooks into the user interface hosting environment and blocks at least one input provided by a user so that the at least one input is not provided to the target application.

54. The computer readable medium of claim 29, wherein the context manager facilitates sharing of the context in accordance with a Clinical Context Object Workgroup (CCOW) standard, wherein the target application has no natively programmed capability to share the context with the first application in accordance with the CCOW standard, and wherein the act (A) comprises an act of:
(A) implementing a manipulator program that provides the target application with the capability to share the context with the first application in accordance with the CCOW standard.

55. The computer readable medium of claim 29, wherein the context comprises a patient encounter subject, a clinical provider subject and an insurer subject.

56. The computer readable medium of claim 55, wherein the context comprises an observation subject.

57. In a computer system comprising a plurality of software applications and a context manager to facilitate sharing of context between at least two of the plurality of software applications, wherein the plurality of software applications comprises a first application and a target application, wherein the target application has no natively programmed capability to share context with the first application, a method comprising an act of:
(A) providing a manipulator program that is external to the target application and provides the target application with the capability to a share context with the first application, wherein the context includes information other than an identity of a user of the target application.

58. The method of claim 57, wherein the act (A) comprises an act of providing a manipulator program that provides the target application with the capability to share a context that includes an identity of the user.

59. In a computer system comprising a target computer having a user interface hosting environment, the target computer having a target application executing thereon, the target application having a user interface executing on the user interface hosting environment, a method comprising an act of:
(A) providing a manipulator program that is external to the target application and hooks into the user interface hosting environment to provide inputs to the target application substantially simultaneously with inputs provided from a user to the target application via the user interface.

60. In a computer system comprising a target computer having a user interface hosting environment, the target computer having a target application executing thereon, the target application having a user interface executing on the user interface hosting environment, a method comprising an act of:
(A) providing a manipulator program that is external to the target application and hooks into at least one application interface for the target application that is not natively programmed to be an interface to an independent external program, wherein the manipulator program is programmed to, after a user has logged into the target application, communicate with the target application via the application interface to provide the target application with a capability to perform at least one function that is not natively programmed into the target application.

61. The method of claim 60, wherein the target application has a user interface executing on a target computer having a user interface hosting environment, wherein the user interface is the at least one application interface, and wherein the act (A) comprises an act of providing a manipulator program that hooks into the user interface and is programmed to communicate with the target application via the user interface to provide the target application with a capability to perform at least one function that is not natively programmed into the target application.

62. The method of claim 60, wherein the target application has a user interface executing on a first computer and another component executing on a second computer, wherein the first and second computers communicate via at least one communication path, wherein the user interface is the at least one communication path, and wherein the act (A) comprises an act of providing a manipulator program that hooks into the at least one communication path and is programmed to communicate with the target application via the at least one communication path to provide the target application with a capability to perform at least one function that is not natively programmed into the target application.

63. A method for use in a computer system comprising at least one computer executing a plurality of applications, the plurality of applications comprising a first application and a target application, wherein the target application has no natively programmed capability to enable the target application to be synchronized with the first application, wherein the target application has a user interface executing on a target computer having a display, the method comprising:
(A) providing a manipulator program that is external to the target application and provides the target application with a capability to perform at least one function that is not natively programmed into the target application and enables the target application to be synchronized with the first application, the at least one function being selected from the group consisting of:
outputting onto a display of the at least one computer information that the target application is not programmed to output;
monitoring a state of the target application and transmitting information to the first application in response to a change in state of the target application; and
filtering information that the target application attempts to output to the display so that the filtered information is not outputted to the display.
